(19) United States
(12) Patent Application Publication
(10) Pub. No.: US 2024/0222681 A1
(43) Pub. Date: Jul. 4, 2024

(54) VEHICLE, BATTERY, AND METHOD OF MANUFACTURING BATTERY

(71) Applicants: HYUNDAI MOTOR COMPANY, Seoul (KR); KIA CORPORATION, Seoul (KR); SEBANG GLOBAL BATTERY CO., LTD., Seoul (KR)

(72) Inventors: Kiyong LEE, Ansan-si (KR); Heegun YANG, Seongnam-si (KR); Sungtae KIM, Yongin-si (KR); Sungjoon KIM, Changwon-si (KR); Seunghwan LEE, Changwon-si (KR); Kyudae LEE, Gyeongsangnam-do (KR)

(73) Assignees: HYUNDAI MOTOR COMPANY, Seoul (KR); KIA CORPORATION, Seoul (KR); SEBANG GLOBAL BATTERY CO., LTD., Seoul (KR)

(21) Appl. No.: 18/530,864

(22) Filed: Dec. 6, 2023

(30) Foreign Application Priority Data
Dec. 29, 2022 (KR) 10-2022-0188287

(51) Int. Cl. H01M 10/04; H01M 4/62; H01M 50/209; H01M 50/249; H01M 50/46

(52) U.S. Cl. CPC H01M 10/0413; H01M 4/621; H01M 50/209; H01M 50/249; H01M 50/46; H01M 2004/021; H01M 2220/20

(57) ABSTRACT

A battery may include a negative plate; and a positive plate, and specifications of the negative plate and the positive plate are applied differently depending on a selection of one from a higher output voltage for a starting performance of an internal combustion engine vehicle or a larger charging capacity for an endurance performance of an eco-friendly vehicle.

### CROSS-REFERENCE TO RELATED APPLICATION

The present application claims priority to Korean Patent Application No. 10-2022-0188287, filed on Dec. 29, 2022, the entire contents of which is incorporated herein for all purposes by this reference.

### BACKGROUND OF THE PRESENT DISCLOSURE

### Field of the Present Disclosure

The present disclosure relates to a vehicle battery for use in an eco-friendly vehicle.

### Description of Related Art

An internal combustion engine vehicle is equipped with a battery as a power source of electrical loads of the internal combustion engine vehicle. That is, the electrical loads of the internal combustion engine vehicle are powered by the battery. The battery of the internal combustion engine vehicle generally outputs a voltage of 12 V.

An eco-friendly vehicle using a motor instead of an internal combustion engine is equipped with a large capacity high-voltage battery to power the motor. The motor of an eco-friendly vehicle receives power from a large capacity high-voltage battery to rotate, generating power for driving the eco-friendly vehicle. Even in eco-friendly vehicles, however, power is required to drive other electrical loads besides the motor, which may require a relatively low capacity low-voltage battery (additional battery) in addition to the large capacity high-voltage battery. For example, to enable over-the-air (OTA) software updates or use a dash cam or built-in cam in eco-friendly vehicles, use of a relatively low-capacity auxiliary battery rather than a large capacity high-voltage battery is more efficient. When an eco-friendly vehicle is parked in a power-off state, disconnection of power supply from the large capacity high-voltage battery is efficient for management of charging power of the large capacity high-voltage battery as well as for safety reasons. In the instant case, use of power of a relatively low capacity low-voltage battery and not the large capacity high-voltage battery, is efficient for OTA software updates or operation of a dash cam.

However, a battery of an internal combustion engine vehicle and a low-voltage battery (auxiliary battery) of an eco-friendly vehicle may have different requirements due to differences in vehicle types. For example, a battery of an internal combustion engine vehicle is used not only for driving electrical loads, but also for starting the internal combustion engine, and thus an instantaneous high-output starting performance (cold cranking ampere, CCA) is required to start the internal combustion engine. By contrast, because an eco-friendly vehicle only requires to drive electrical loads without starting an internal combustion engine, a larger capacity battery for frequent power use (endurance performance) is required rather than a high-output starting performance.

In general, a 12V vehicle battery is to implement a high-output starting performance for an internal combustion engine vehicle. Accordingly, a low-voltage battery (auxiliary battery) for eco-friendly vehicles requires to be developed.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a battery more suitable for eco-friendly vehicles, more particularly, a battery with a larger charging capacity (endurance performance) for eco-friendly vehicles rather than a high-output battery for internal combustion engine vehicles.

Additional aspects of the present disclosure will be set forth in part in the description which follows, and in part, will be obvious from the description, or may be learned by practice of the present disclosure.

According to an aspect of the present disclosure, a battery includes: a negative plate; and a positive plate. Specifications of the negative plate and the positive plate are applied differently depending on a selection of one from a higher output voltage for a starting performance of an internal combustion engine vehicle or a larger charging capacity for an endurance performance of an eco-friendly vehicle.

In the battery, a number of negative plates and a number of positive plates are applied differently depending on the selection of the one from the higher output voltage for the starting performance of the internal combustion engine vehicle or the larger charging capacity for the endurance performance of the eco-friendly vehicle.

In the battery, a number of negative plates and a number of positive plates for the endurance performance of the eco-friendly vehicle is one less than a number of negative plates and a number of positive plates for the starting performance of the internal combustion engine vehicle, respectively.

In the battery, the number of negative plates and the number of positive plates for the endurance performance of the eco-friendly vehicle are six and five, respectively.

In the battery, the negative plate includes a grid, an electroactive paste, and a separator, and a thickness of the grid of the negative plate for the endurance performance of the eco-friendly vehicle is 110 to 125% greater than a thickness of the grid of the negative plate for the starting performance of the internal combustion engine vehicle.

In the battery, the negative plate includes the grid, the electroactive paste, and the separator, and the thickness of the grid of the negative plate for the endurance performance of the eco-friendly vehicle is 110 to 125% of the thickness of the grid of the negative plate for the starting performance of the internal combustion engine vehicle.

In the battery, an amount of electroactive paste of the negative plate for the endurance performance of the eco-friendly vehicle is 110 to 130% of an amount of electroactive paste of the negative plate for the starting performance of the internal combustion engine vehicle.

In the battery, a thickness of the separator of the negative plate for the endurance performance of the eco-friendly vehicle is 110 to 125% of a thickness of the separator of the negative plate for the starting performance of the internal combustion engine vehicle.

In the battery, the electroactive paste further includes an additive for increasing bonding of the grid and the electroactive paste, and an amount of additive of the electroactive paste of the negative plate for the endurance performance of the eco-friendly vehicle is 50 to 90% of an amount of additive of the electroactive paste of the negative plate for the starting performance of the internal combustion engine vehicle.

In the battery, the positive plate includes a grid and an electroactive paste, and a thickness of the grid of the positive plate for the endurance performance of the eco-friendly vehicle is 110 to 130% of a thickness of the grid of the positive plate for the starting performance of the internal combustion engine vehicle.

In the battery, an amount of electroactive paste of the positive plate for the endurance performance of the eco-friendly vehicle is 110 to 130% of an amount of electroactive paste of the positive plate for the starting performance of the internal combustion engine vehicle.

In the battery, the electroactive paste further includes an additive for increasing bonding of the grid and the electroactive paste, and an amount of additive of the electroactive paste of the positive plate for the endurance performance of the eco-friendly vehicle is 50 to 90% of an amount of additive of the electroactive paste of the positive plate for the starting performance of the internal combustion engine vehicle.

According to an aspect of the present disclosure, a method of manufacturing a battery including a negative plate and a positive plate includes: determining specifications of the negative plate and the positive plate differently depending on a selection of one from a higher output voltage for a starting performance of an internal combustion engine vehicle or a larger charging capacity for an endurance performance of an eco-friendly vehicle; and manufacturing the battery by applying the determined specification.

According to an aspect of the present disclosure, a vehicle includes: a motor configured to generate power for driving; a first battery configured to supply power to the motor; and a second battery configured to supply power to remaining electrical loads except for the motor. The second battery includes: a negative plate; and a positive plate. Specifications of the negative plate and the positive plate are applied differently depending on a selection of one from a higher output voltage for a starting performance of an internal combustion engine vehicle or a larger charging capacity for an endurance performance of an eco-friendly vehicle. A number of negative plates and a number of positive plates are applied differently depending on the selection of the one from the higher output voltage for the starting performance of the internal combustion engine vehicle or the larger charging capacity for the endurance performance of the eco-friendly vehicle.

In the vehicle, the negative plate includes a grid, an electroactive paste, and a separator, and a thickness of the grid of the negative plate for the endurance performance of the eco-friendly vehicle is 110 to 125% greater than a thickness of the grid of the negative plate for the starting performance of the internal combustion engine vehicle.

In the vehicle, the negative plate includes the grid, the electroactive paste, and the separator, and the thickness of the grid of the negative plate for the endurance performance of the eco-friendly vehicle is 110 to 125% of the thickness of the grid of the negative plate for the starting performance of the internal combustion engine vehicle.

In the vehicle, an amount of electroactive paste of the negative plate for the endurance performance of the eco-friendly vehicle is 110 to 130% of an amount of electroactive paste of the negative plate for the starting performance of the internal combustion engine vehicle.

In the vehicle, a thickness of the separator of the negative plate for the endurance performance of the eco-friendly vehicle is 110 to 125% of a thickness of the separator of the negative plate for the starting performance of the internal combustion engine vehicle.

In the vehicle, the positive plate includes a grid and an electroactive paste, and a thickness of the grid of the positive plate for the endurance performance of the eco-friendly vehicle is 110 to 130% of a thickness of the grid of the positive plate for the starting performance of the internal combustion engine vehicle.

In the vehicle, an amount of electroactive paste of the positive plate for the endurance performance of the eco-friendly vehicle is 110 to 130% of an amount of electroactive paste of the positive plate for the starting performance of the internal combustion engine vehicle.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a diagram illustrating an eco-friendly vehicle according to an exemplary embodiment of the present disclosure;

FIG. 2 is a diagram illustrating a power supply device of an eco-friendly vehicle according to an exemplary embodiment of the present disclosure;

FIG. 3 is a diagram illustrating an absorbent glass mat (AGM) battery of FIG. 1 and FIG. 2;

FIG. 4 is a diagram illustrating a unit battery cell of the AGM battery of FIG. 3; and

FIG. 5 illustrates specification comparison between an AGM battery for internal combustion engine vehicles and an AGM battery according to an exemplary embodiment of the present disclosure.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Like reference numerals throughout the specification denote like elements. Also, the present specification does not describe all the elements according to various exemplary embodiments of the present disclosure, and descriptions well-known in the art to which the present disclosure pertains or overlapped portions are omitted. The terms such as “part”, “˜module”, and the like may refer to at least one process processed by at least one hardware or software. According to various exemplary embodiments of the present disclosure, a plurality of “˜parts”, “˜modules” may be embodied as a single element, or a single of a “part”, “˜module” may include a plurality of elements.

It should be understood that when an element is referred to as being “connected” to another element, it may be directly or indirectly connected to the other element, wherein the indirect connection includes “connection” via a wireless communication network.

It should be understood that the term “include” when used in the present specification, specifies the presence of stated features, integers, steps, operations, elements, and/or components, but does not preclude the presence or addition of at least one other features, integers, steps, operations, elements, components, and/or groups thereof.

It should be understood that when it is stated in the present specification that a member is located “on” another member, not only a member may be in contact with another member, but also yet another member may be present between the two members.

It should be understood that, although the terms first, second, etc. may be used herein to describe various elements, these elements should not be limited by these terms.

It is to be understood that the singular forms are intended to include the plural forms as well, unless the context clearly dictates otherwise.

Reference numerals used for method steps are just used for convenience of explanation, but not to limit an order of the steps. Thus, unless the context clearly dictates otherwise, the written order may be practiced otherwise.

Hereinafter, an operation principle and embodiments of the present disclosure are described in detail with reference to the accompanying drawings.

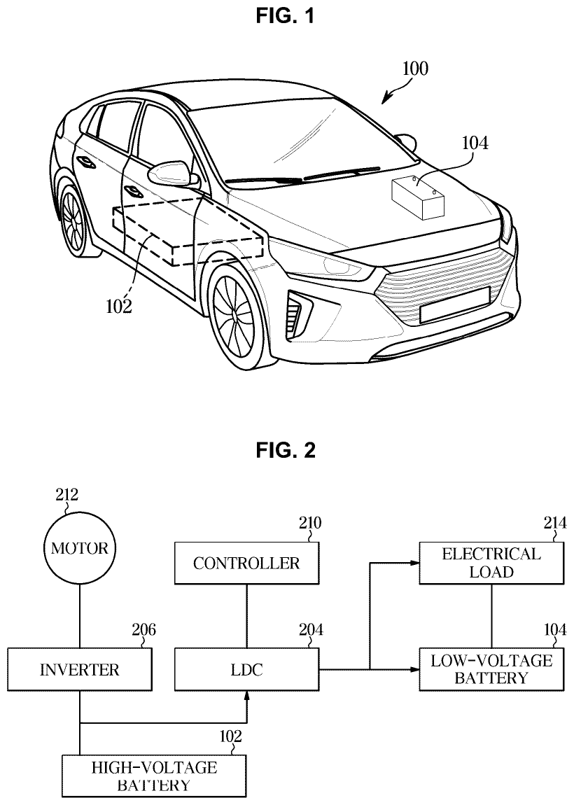

FIG. 1 is a diagram illustrating an eco-friendly vehicle according to an exemplary embodiment of the present disclosure.

An eco-friendly vehicle 100 shown in FIG. 1 includes a motor (refer to a motor 212 of FIG. 2) for generating a driving force. Accordingly, the eco-friendly vehicle 100 includes a large capacity high-voltage battery 102 (a first battery) storing power for driving the motor 212. According to an exemplary embodiment of the present disclosure, the high-voltage battery 102 is provided in a lower space of a second row passenger seats in the eco-friendly vehicle 100. Electric power stored in the high-voltage battery 102 may be used to generate power for driving the motor 212. The high-voltage battery 102 according to various exemplary embodiments of the present disclosure may be a lithium battery.

According to an exemplary embodiment of the present disclosure, the eco-friendly vehicle 100 further includes an absorbent glass mat (AGM) battery 104 (a second battery) in addition to the high-voltage battery 102. The AGM battery 104 according to an exemplary embodiment of the present disclosure utilizes an absorbent glass mat as a medium. The AGM battery 104 may supply power to electrical loads of the eco-friendly vehicle 100, when not using the high-voltage battery 102 or by assisting the high-voltage battery 102. An output voltage of the AGM battery 104 is lower than that of the high-voltage battery 102. For example, the output voltage of the AGM battery 104 may be 12V.

A charging socket is provided in the eco-friendly vehicle 100. The charging socket is connected to a charging connector of an external slow charger to charge the high-voltage battery 102. That is, by connecting the charging connector of the slow charger to the charging socket of the eco-friendly vehicle 100, the high-voltage battery 102 of the eco-friendly vehicle 100 is charged.

FIG. 2 is a diagram illustrating a power supply device of an eco-friendly vehicle according to an exemplary embodiment of the present disclosure. The power supply device of FIG. 2 is for supplying power to the motor 212 and an electrical load 214.

As shown in FIG. 2, the power supply device of the eco-friendly vehicle 100 according to an exemplary embodiment of the present disclosure includes the high-voltage battery 102, a low voltage DC-DC converter (LDC, 204), an inverter 206, the AGM battery 104, and a controller 210.

The LDC 204 converts a high-voltage direct current of the high-voltage battery 102 into a lower-voltage DC. The LDC 204 converts a high DC voltage of the high-voltage battery 102 into an alternating current, steps down the alternating current through a coil, transformer, capacitor, and the like, rectifies and converts into a lower DC voltage. The DC voltage step-down by the LDC 204 is supplied to each of the electrical loads 214 requiring a low voltage. Furthermore, power of the high-voltage battery 102 may be transferred to the AGM battery 104 through the LDC 204 and used to charge the AGM battery 104.

The DC voltage of the high-voltage battery 102 is converted into an alternating voltage including a predetermined phase and frequency by the inverter 206, and then supplied to the motor 212. A torque and speed of the motor 212 are determined by an output voltage of the inverter 206. The controller 210 is configured to control overall operations of the power supply device.

The controller 210 may be implemented as a memory that stores an algorithm for controlling operations of constituent components of the power supply device or data about a program that reproduces the algorithm, and a processor that is configured to perform the above-described operations using the data stored in the memory. In the present instance, the memory and the processor may be provided as one chip, or provided as separate chips.

At least one constituent component may be added or omitted corresponding to the performance of the constituent components of the power supply device illustrated in FIG. 2. Also, it will be easily understood by those skilled in the art that mutual positions of the constituent components may be modified corresponding to the performance or structure of system.

Meanwhile, a portion of constituent components shown in FIG. 2 refer to a software, and/or a hardware component such as a field-programmable gate array (FPGA) or an application-specific integrated circuit (ASIC).

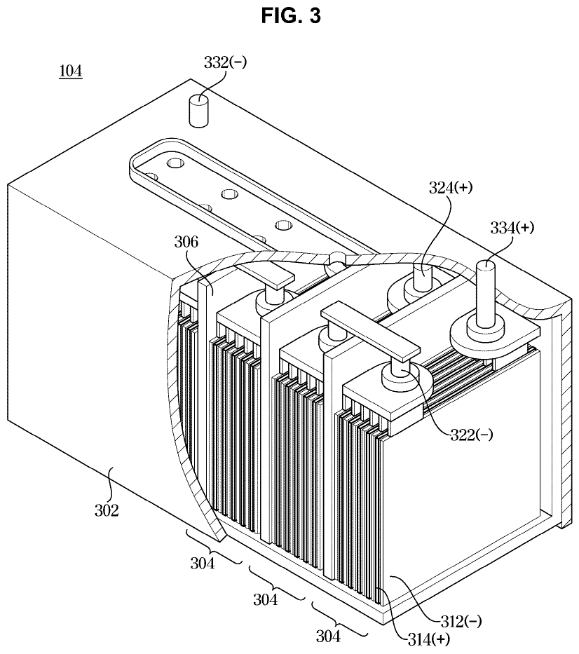

FIG. 3 is a diagram illustrating an AGM battery of FIG. 1 and FIG. 2.

As shown in FIG. 3, the AGM battery 104 is protected by a case 302.

A plurality of battery cells 304 are provided inside the case 302. Six battery cells 304 may be provided. When 2V is output from a single battery cell 304, a total voltage of 12V may be output from the six battery cells 304.

Cell dividers 306 are provided between battery cells 304 adjacent to each other. The cell dividers 306 are for physically separating each of the battery cells 304. The cell dividers 306 may be omitted.

Each of the battery cells 304 (i.e., a single battery cell 304) may include a plurality of negative plates 312 and a plurality of positive plates 314. For example, as shown in FIG. 3, a single battery cell 304 may include six negative plates 312 and five positive plates 314. That is, the number of the negative plates 312 is one more than the number of the positive plates 314. In a single battery cell 304, the negative plates 312 and the positive plates 314 are alternately arranged. When the negative plates 312 are indicated by (−) and the positive plates 314 are indicated by (+), the negative plates 312 and the positive plates 314 are arranged in an order of ‘(−)(+)(−)(+)(−)(+)(−)(+)(−)(+)(−)’.

The negative plates 312 of each of the battery cells 304 may be electrically connected to each other through negative plate connectors 322. The negative plate connectors 322 are finally connected to a negative electrode 332. Similarly, the positive plates 314 of each of the battery cells 304 may be electrically connected to each other through positive plate connectors 324. The positive plate connectors 324 are finally connected to a positive electrode 334. When an output voltage of each of the battery cells 304 is 2V, a voltage of 12V may be output between the negative electrode 332 and the positive electrode 334 by the above electrical series connection structure of the AGM battery 104.

For example, the negative plates 312 may be made of graphite, and generate current by storing or releasing lithium ions of the positive plates 314. A structure of the negative plates 312 determines a capacity (endurance performance) of the AGM battery 104.

For example, the positive plates 314 may be a substance including lithium oxide.

Although not illustrated in FIG. 3, the AGM battery 104 may further include a plurality of valves for discharging heat and gases to outside the case 302 when the heat and gases generated by chemical action during charging and discharging of the AGM battery 104 exceed a certain level.

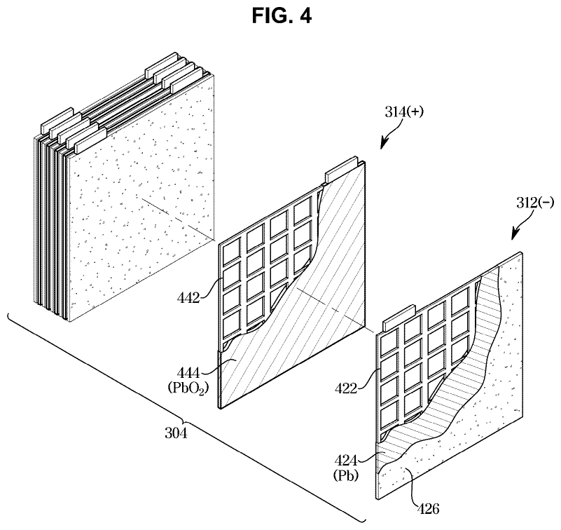

FIG. 4 is a diagram illustrating a unit battery cell of the AGM battery of FIG. 3.

The following characteristics have been described with reference to FIG. 3. That is, in each of the battery cells 304 (i.e., a single battery cell 304), six negative plates 312 and five positive plates 314 are alternately arranged. For example, the negative plates 312 may be made of graphite, and generate current by storing or releasing lithium ions of the positive plates 314. A structure of the negative plates 312 determines a capacity (endurance performance) of the AGM battery 104. For example, the positive plates 314 may be a substance including lithium oxide.

The above-described structures of the negative plates 312 and the positive plates 314 are described in greater detail with reference to FIG. 4.

As shown in FIG. 4, five negative plates 312 and four positive plates 314 are alternately arranged. Although it is shown in FIG. 4 that a spacing between the negative plate 312 and the positive plate 314 is wide to illustrate the structure of the negative plates 312 and the positive plates 314, the spacing between the negative plate 312 and the positive plate 314 is much narrower than shown in FIG. 4 to implement the actual AGM battery 104.

In FIG. 4, the negative plate 312 includes a grid 422, an electroactive paste 424, and a separator 426. In addition to serving to support the electroactive paste 424, the grid 422 of the negative plate 312 is configured to conduct electrons in the battery cell 304.

The material of the grid 422 of the negative plate 312 may be lead.

The electroactive paste 424 applied to a surface of the grid 422 of the negative plate 312 may be lead Pb. A predetermined additive may be added to the electroactive paste 424. The additive of the electroactive paste 424 may be for increasing a bonding force of the grid 422 and the electroactive paste 424.

The separator 426 corresponding to an outermost surface of the negative plate 312 is for electrically separating the negative plate 312 and the positive plate 314. That is, the separator 426 of the negative plate 312 is for preventing the grid 422 and the electroactive paste 424 of the negative plate 312 from being physically contact with a grid 442 and an electroactive paste 444 of the positive plate 314 to be described later. Also, the separator 426 may allow ions to move between the negative plate 312 and the positive plate 314. To the present end, the separator 426 may be made of porous material. Charging and discharging of the battery cell 304 may be performed by the movement of ions through the separator 426.

A charging capacity of the battery cells 304 may be determined by a thickness of the grid 422 of the negative plate 312, the amount of electroactive paste 424, and a thickness of the separator 426. For example, the greater the thickness of the grid 422 of the negative plate 312, the greater the amount of electroactive paste 424, the greater the thickness of the separator 426, and the greater the amount of additive of the electroactive paste 424 (also depending on a type of the additive), the charging capacity of the battery cells 304 increases.

In FIG. 4, the positive plate 314 includes the grid 442 and the electroactive paste 444. Unlike the negative plate 312 described above, the positive plate 314 does not include a separator. The grid 442 of the positive plate 314 is configured to support the electroactive paste 444 and conduct electrons in the battery cell 304. The material of the grid 442 of the positive plate 314 may be lead.

The electroactive paste 444 applied to a surface of the grid 442 of the positive plate 314 may be lead dioxide PbO₂. A predetermined additive may be added to the electroactive paste 444. The additive of the electroactive paste 444 may be for increasing a bonding force of the grid 442 and the electroactive paste 444.

The charging capacity of the battery cells 304 may be determined by a thickness of the grid 442 of the positive plate 314, the amount of electroactive paste 444, and a type and the amount of additive. For example, the greater the thickness of the grid 442 of the positive plate 314, the greater the amount of electroactive paste 444, and the greater the amount of additive of the electroactive paste 444 (also depending on a type of the additive), the charging capacity of the battery cells 304 increases.

By changing specifications of the negative plate 312 and the positive plate 314 of the AGM battery 104 in design and manufacturing process of the AGM battery 104, the AGM battery 104 including electrical characteristics more suitable for the eco-friendly vehicle 100 may be designed and manufactured. That is, by adjusting a thickness of the grid of each of the negative plate 312 and the positive plate 314, the amount of electroactive paste of each of the negative plate 312 and the positive plate 314, a type and the amount of additive, and a thickness of the separator 426 of the negative plate 312, the charging capacity (endurance performance) of the battery cells 304 may be increased. Accordingly, the AGM battery 104 with electrical characteristics more suitable for the eco-friendly vehicle 100 that requires a larger charging capacity (endurance performance) may be designed and manufactured.

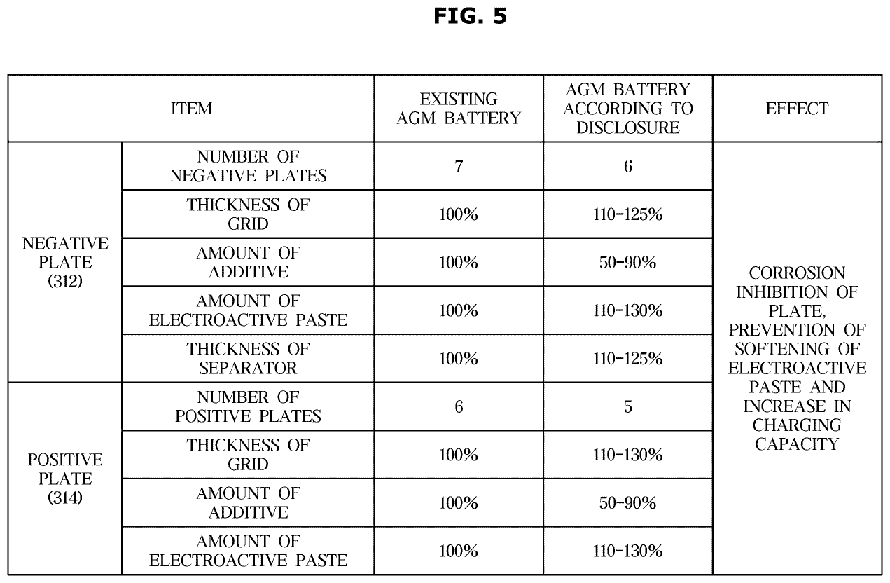

For example, with assumptions that a specification of an AGM battery for internal combustion engine vehicles requiring instantaneous high-output starting performance (cold cranking ampere, CCA) is 100%, a specification of the AGM battery 104 for the eco-friendly vehicle 100 according to an exemplary embodiment of the present disclosure is shown in FIG. 5.

FIG. 5 illustrates specification comparison between an AGM battery for internal combustion engine vehicles and an AGM battery according to an exemplary embodiment of the present disclosure.

As shown in FIG. 5, a thickness of the grid 422 of the negative plate 312 may be increased from 100% conventionally to 110˜125% according to an exemplary embodiment of the present disclosure. Alternatively, the amount of additive of the negative plate 312 may be decreased from 100% conventionally to 50˜90% according to an exemplary embodiment of the present disclosure. Alternatively, the amount of electroactive paste 424 of the negative plate 312 may be increased from 100% conventionally to 110˜130% according to an exemplary embodiment of the present disclosure. Alternatively, a thickness of the separator 426 of the negative plate 312 may be increased from 100% conventionally to 110˜125% according to an exemplary embodiment of the present disclosure.

Furthermore, a thickness of the grid 442 of the positive plate 314 may be increased from 100% conventionally to 110˜130% according to an exemplary embodiment of the present disclosure. Alternatively, the amount of additive of the positive plate 314 may be decreased from 100% conventionally to 50˜90% according to an exemplary embodiment of the present disclosure. Alternatively, the amount of electroactive paste 444 of the positive plate 314 may be increased from 100% conventionally to 110˜130% according to an exemplary embodiment of the present disclosure.

As described above, through the change of specification of the negative plate 312 or the positive plate 314, a charging capacity (endurance performance) of the battery cells 304 may be increased, designing and manufacturing the AGM battery 104 including electrical characteristics more suitable for the eco-friendly vehicle 100 that requires greater charging capacity (endurance performance).

Meanwhile, the above-described embodiments may be stored in a form of a recording medium storing computer-executable instructions. The instructions may be stored in a form of a program code, and when executed by a processor, the instructions may perform operations of the disclosed exemplary embodiments of the present disclosure. The recording medium may be implemented as a computer-readable recording medium.

The computer-readable recording medium includes all kinds of recording media in which instructions which may be decoded by a computer are stored of, for example, a read only memory (ROM), random access memory (RAM), magnetic tapes, magnetic disks, flash memories, optical recording medium, and the like.

As is apparent from the above, according to the exemplary embodiments of the present disclosure, a battery more suitable for eco-friendly vehicles may be provided, responding to power consumption more efficiently for the use of convenience functions of an eco-friendly vehicle, while parked.

According to the exemplary embodiments of the present disclosure, a separate auxiliary battery for a dash cam or a built-in cam in an eco-friendly vehicle may be removed by increasing a battery charging capacity (endurance performance) of the eco-friendly vehicle.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured to process data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A battery, comprising:
a negative plate; and
a positive plate,
wherein specifications of the negative plate and the positive plate are applied differently depending on a selection of one from a higher output voltage for a starting performance of an internal combustion engine vehicle or a larger charging capacity for an endurance performance of an eco-friendly vehicle.

2. The battery of claim 1, wherein a number of negative plates and a number of positive plates are applied differently depending on the selection of the one from the higher output voltage for the starting performance of the internal combustion engine vehicle or the larger charging capacity for the endurance performance of the eco-friendly vehicle.

3. The battery of claim 2, wherein a number of negative plates and a number of positive plates for the endurance performance of the eco-friendly vehicle is one less than a number of negative plates and a number of positive plates for the starting performance of the internal combustion engine vehicle, respectively.

4. The battery of claim 3, wherein the number of negative plates and the number of positive plates for the endurance performance of the eco-friendly vehicle are six and five, respectively.

5. The battery of claim 3,
wherein the negative plate includes a grid, an electroactive paste, and a separator, and
wherein a thickness of the grid of the negative plate for the endurance performance of the eco-friendly vehicle is 110 to 125% greater than a thickness of the grid of the negative plate for the starting performance of the internal combustion engine vehicle.

6. The battery of claim 5,
wherein the negative plate includes the grid, the electroactive paste, and the separator, and
wherein the thickness of the grid of the negative plate for the endurance performance of the eco-friendly vehicle is 110 to 125% of the thickness of the grid of the negative plate for the starting performance of the internal combustion engine vehicle.

7. The battery of claim 6, wherein an amount of electroactive paste of the negative plate for the endurance performance of the eco-friendly vehicle is 110 to 130% of an amount of electroactive paste of the negative plate for the starting performance of the internal combustion engine vehicle.

8. The battery of claim 6, wherein a thickness of the separator of the negative plate for the endurance performance of the eco-friendly vehicle is 110 to 125% of a thickness of the separator of the negative plate for the starting performance of the internal combustion engine vehicle.

9. The battery of claim 6,
wherein the electroactive paste further includes an additive for increasing bonding of the grid and the electroactive paste, and
wherein an amount of additive of the electroactive paste of the negative plate for the endurance performance of the eco-friendly vehicle is 50 to 90% of an amount of additive of the electroactive paste of the negative plate for the starting performance of the internal combustion engine vehicle.

10. The battery of claim 3,
wherein the positive plate includes a grid and an electroactive paste, and
wherein a thickness of the grid of the positive plate for the endurance performance of the eco-friendly vehicle is 110 to 130% of a thickness of the grid of the positive plate for the starting performance of the internal combustion engine vehicle.

11. The battery of claim 10, wherein an amount of electroactive paste of the positive plate for the endurance performance of the eco-friendly vehicle is 110 to 130% of an amount of electroactive paste of the positive plate for the starting performance of the internal combustion engine vehicle.

12. The battery of claim 10,
wherein the electroactive paste further includes an additive for increasing bonding of the grid and the electroactive paste, and
wherein an amount of additive of the electroactive paste of the positive plate for the endurance performance of the eco-friendly vehicle is 50 to 90% of an amount of additive of the electroactive paste of the positive plate for the starting performance of the internal combustion engine vehicle.

13. A method of manufacturing a battery including a negative plate and a positive plate, the method comprising:
determining specifications of the negative plate and the positive plate differently depending on a selection of one from a higher output voltage for a starting performance of an internal combustion engine vehicle or a larger charging capacity for an endurance performance of an eco-friendly vehicle; and
manufacturing the battery by applying the determined specification.

14. A vehicle, comprising:
a motor configured to generate power for driving;
a first battery configured to supply power to the motor; and
a second battery configured to supply power to remaining electrical loads except for the motor,
wherein the second battery includes:
a negative plate; and
a positive plate, and
wherein specifications of the negative plate and the positive plate are applied differently depending on a selection of one from a higher output voltage for a starting performance of an internal combustion engine vehicle or a larger charging capacity for an endurance performance of an eco-friendly vehicle, and
wherein a number of negative plates and a number of positive plates are applied differently depending on the selection of the one from the higher output voltage for the starting performance of the internal combustion engine vehicle or the larger charging capacity for the endurance performance of the eco-friendly vehicle.

15. The vehicle of claim 14,
wherein the negative plate includes a grid, an electroactive paste, and a separator, and
wherein a thickness of the grid of the negative plate for the endurance performance of the eco-friendly vehicle is 110 to 125% greater than a thickness of the grid of the negative plate for the starting performance of the internal combustion engine vehicle.

16. The vehicle of claim 15,
wherein the negative plate includes the grid, the electroactive paste, and the separator, and
wherein the thickness of the grid of the negative plate for the endurance performance of the eco-friendly vehicle is 110 to 125% of the thickness of the grid of the negative plate for the starting performance of the internal combustion engine vehicle.

17. The vehicle of claim 16, wherein an amount of electroactive paste of the negative plate for the endurance performance of the eco-friendly vehicle is 110 to 130% of an amount of electroactive paste of the negative plate for the starting performance of the internal combustion engine vehicle.

18. The vehicle of claim 16, wherein a thickness of the separator of the negative plate for the endurance performance of the eco-friendly vehicle is 110 to 125% of a thickness of the separator of the negative plate for the starting performance of the internal combustion engine vehicle.

19. The vehicle of claim 14,
wherein the positive plate includes a grid and an electroactive paste, and
wherein a thickness of the grid of the positive plate for the endurance performance of the eco-friendly vehicle is 110 to 130% of a thickness of the grid of the positive plate for the starting performance of the internal combustion engine vehicle.

20. The vehicle of claim 19, wherein an amount of electroactive paste of the positive plate for the endurance performance of the eco-friendly vehicle is 110 to 130% of an amount of electroactive paste of the positive plate for the starting performance of the internal combustion engine vehicle.
